(19) United States
(12) Patent Application Publication
(10) Pub. No.: US 2026/0269466 A1
(43) Pub. Date: Sep. 10, 2026

(54) ANTENNA STRUCTURE

(71) Applicant: WNC Corporation, Hsinchu (TW)

(72) Inventors: Tzu-Kuan SUN, Hsinchu (TW); Chung-Che LIEN, Hsinchu (TW)

(21) Appl. No.: 19/535,223

(22) Filed: Feb. 10, 2026

(30) Foreign Application Priority Data
Mar. 7, 2025 (TW) 114108472

(51) Int. Cl. H01Q 1/50; G01D 5/20; H01Q 1/22

(52) U.S. Cl. CPC H01Q 1/50; G01D 5/20; H01Q 1/22

(57) ABSTRACT

An antenna structure includes a first radiation element, a second radiation element, a third radiation element, a connection metal element, a tunable capacitor, a first capacitor, a second capacitor, and a first inductor. The first radiation element is coupled through the first capacitor to a signal source. The second radiation element is coupled to the first radiation element. The second radiation element is also coupled through the second capacitor to a ground voltage. The third radiation element is coupled to the first radiation element. The connection metal element is coupled through the first inductor to the first radiation element or the second radiation element. The tunable capacitor generates a variable capacitance according to a first control signal. The connection metal element is also coupled through the tunable capacitor to the ground voltage.

### CROSS-REFERENCE TO RELATED PATENT APPLICATION

This application claims the benefit of priority to Taiwan Patent Application No. 114108472, filed on Mar. 7, 2025. The entire content of the above identified application is incorporated herein by reference.

### FIELD OF THE DISCLOSURE

The present disclosure relates to an antenna structure, and more particularly to a broadband antenna structure.

### BACKGROUND OF THE DISCLOSURE

With the development of mobile communication technology, mobile devices have become increasingly prevalent in recent years. Common examples include notebook computers, mobile phones, multimedia players, and other portable electronic devices with hybrid functions. To meet user needs, mobile devices usually have wireless communication capabilities. Some cover long-range wireless communication ranges; for example, mobile phones use 2G, 3G, and LTE (Long Term Evolution) systems and communicate over the frequency bands of 700MHz, 850 MHz, 900MHz, 1800MHz, 1900MHz, 2100MHz, 2300MHz, and 2500MHz. Others cover short-range wireless communication ranges; for example, Wi-Fi and Bluetooth systems communicate over the 2.4GHz, 5.2GHz, and 5.8GHz bands.

An antenna is an indispensable component in the field of wireless communication. If the bandwidth of an antenna used to receive or transmit signals is insufficient, the communication quality of a mobile device can readily deteriorate. Therefore, how to design antenna components that are compact in size and have a wide bandwidth is an important issue for antenna designers.

### SUMMARY OF THE DISCLOSURE

In an exemplary embodiment, the present disclosure provides an antenna structure that includes a first radiation element, a second radiation element, a third radiation element, a connection metal element, a tunable capacitor, a first capacitor, a second capacitor, and a first inductor. The first radiation element is coupled through the first capacitor to a signal source. The second radiation element is coupled to the first radiation element and is further coupled through the second capacitor to a ground voltage. The third radiation element is coupled to the first radiation element. The connection metal element is coupled through the first inductor to the first radiation element or the second radiation element. The tunable capacitor generates a variable capacitance according to a first control signal, and the connection metal element is further coupled through the tunable capacitor to the ground voltage.

In another exemplary embodiment, the present disclosure provides an antenna structure that includes a first radiation element, a second radiation element, a third radiation element, a fourth radiation element, a connection metal element, a tunable capacitor, and a first inductor. The first radiation element is coupled to a signal source. The second radiation element is coupled to the first radiation element, and the third radiation element is coupled to the first radiation element, wherein the second radiation element and the third radiation element extend substantially in opposite directions. The fourth radiation element is coupled to a ground voltage and is adjacent to the third radiation element. The connection metal element is coupled through the first inductor to the first radiation element; and the tunable capacitor generates a variable capacitance value according to a first control signal, wherein the connection metal element is further coupled through the tunable capacitor to the ground voltage.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

FIG. 1 is a schematic diagram of an antenna structure according to an embodiment of the present disclosure.

FIG. 2 is a schematic diagram of an antenna structure according to an embodiment of the present disclosure.

FIG. 3 is a structural diagram of a tunable circuit according to an embodiment of the present disclosure.

FIG. 4 is a schematic diagram of an antenna structure according to an embodiment of the present disclosure.

FIG. 5 is a schematic diagram of an antenna structure according to another embodiment of the present disclosure.

### DETAILED DESCRIPTION OF THE EXEMPLARY EMBODIMENTS

In order to illustrate the purposes, features and advantages of the disclosure, the embodiments and figures of the disclosure are shown in detail as follows.

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to…”. The term “substantially” means the value is within an acceptable error range. One skilled in the art can solve the technical problem within a predetermined error range and achieve the proposed technical performance. Also, the term “couple” is intended to mean either an indirect or direct electrical connection. Accordingly, if one device is coupled to another device, that connection may be through a direct electrical connection, or through an indirect electrical connection via other devices and connections.

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Furthermore, spatially relative terms, such as “beneath,” “below,” “lower,” “above,” “upper” and the like, may be used herein for ease of description to describe one element or feature’s relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

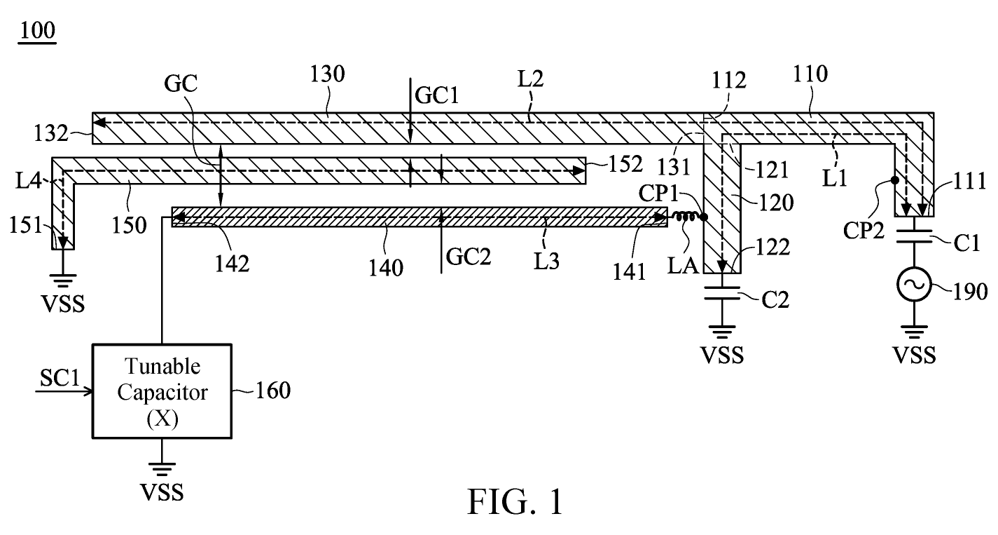

FIG. 1 is a schematic diagram showing an antenna structure 100 according to an embodiment of the present disclosure. The antenna structure 100 can be applied in a mobile device, for example, a smart phone, a tablet computer, or a notebook computer. In the embodiment of FIG. 1, the antenna structure 100 includes at least: a first radiation element 110, a second radiation element 120, a third radiation element 130, a connection metal element 140, a tunable capacitor 160, a first inductor LA, a first capacitor C1, and a second capacitor C2, wherein the first radiation element 110, the second radiation element 120, and the third radiation element 130 can all be made of a metal material, for example, copper, silver, aluminum, iron, or an alloy thereof.

For example, the first radiation element 110 may substantially have a relatively small L-shape, but is not limited thereto. In detail, the first radiation element 110 has a first end 111 and a second end 112, wherein the first end 111 of the first radiation element 110 is coupled through the first capacitor C1 to a signal source 190. In some embodiments, the signal source 190 may be a radio frequency (RF) module that can be used to excite the antenna structure 100.

For example, the second radiation element 120 may substantially have a short straight strip shape, but is not limited thereto. In detail, the second radiation element 120 has a first end 121 and a second end 122, wherein the first end 121 of the second radiation element 120 is coupled to the second end 112 of the first radiation element 110, and the second end 122 of the second radiation element 120 is coupled through the second capacitor C2 to a ground voltage VSS. In some embodiments, the ground voltage VSS may be provided by a system ground plane of the antenna structure 100 (not shown).

For example, the third radiation element 130 may substantially have a relatively long straight strip shape (relative to the second radiation element 120), and may be substantially perpendicular to the second radiation element 120, but is not limited thereto. In detail, the third radiation element 130 has a first end 131 and a second end 132, wherein the first end 131 of the third radiation element 130 is coupled to the second end 112 of the first radiation element 110, and the second end 132 of the third radiation element 130 is an open end. In some embodiments, the combination of the first radiation element 110, the second radiation element 120, and the third radiation element 130 may substantially have an F-shape.

For example, the connection metal element 140 may substantially have a straight strip shape, and may be substantially parallel to the third radiation element 130, but is not limited thereto. In detail, the connection metal element 140 has a first end 141 and a second end 142, wherein the first end 141 of the connection metal element 140 is coupled through the first inductor LA to a first connection point CP1 on the second radiation element 120, and the second end 142 of the connection metal element 140 is coupled through the tunable capacitor 160 to the ground voltage VSS. In some embodiments, the connection metal element 140 is adjacent to the third radiation element 130, and a coupling gap GC may be formed between the third radiation element 130 and the connection metal element 140. In addition, the tunable capacitor 160 generates a variable capacitance value X according to a first control signal SC1. However, the present disclosure is not limited thereto. In other embodiments, the antenna structure 100 can also be adjusted such that the first end 141 of the connection metal element 140 is changed to be coupled through the first inductor LA to a second connection point CP2 on the first radiation element 110. It must be understood that the term “near” or “adjacent” in this specification may refer to the distance (spacing) between the corresponding two elements being smaller than a predetermined distance (for example, 10 mm or shorter), but generally does not include the case where the corresponding two elements are in direct contact with each other (that is, the aforementioned distance is reduced to 0).

In some embodiments, the antenna structure 100 further includes a fourth radiation element 150, which can be made of a metal material. For example, the fourth radiation element 150 may substantially have a relatively large L-shape (relative to the first radiation element 110), and may be disposed between the third radiation element 130 and the connection metal element 140, but is not limited thereto. In detail, the fourth radiation element 150 has a first end 151 and a second end 152, wherein the first end 151 of the fourth radiation element 150 is coupled to the ground voltage VSS, and the second end 152 of the fourth radiation element 150 is an open end and extends in a direction toward the second radiation element 120. In some embodiments, the fourth radiation element 150 is adjacent to the third radiation element 130, and a first coupling gap GC1 may be formed between the third radiation element 130 and the fourth radiation element 150. In some embodiments, the fourth radiation element 150 is adjacent to the connection metal element 140, and a second coupling gap GC2 may be formed between the connection metal element 140 and the fourth radiation element 150. In addition, the fourth radiation element 150 can be an optional component and can also be removed in other embodiments.

In some embodiments, the antenna structure 100 may cover a first frequency band, a second frequency band, and a third frequency band. For example, the aforementioned first frequency band may be from 617 MHz to 960 MHz, the aforementioned second frequency band may be from 1400 MHz to 2690 MHz, and the aforementioned third frequency band may be from 3300 MHz to 5925 MHz. Therefore, the antenna structure 100 will at least be able to support broadband operation of LTE (Long Term Evolution).

In some embodiments, the operating principle of the antenna structure 100 may be as described below. The first radiation element 110 and the third radiation element 130 can be excited to generate the aforementioned first frequency band and second frequency band. The first radiation element 110 and the second radiation element 120 can be excited to generate the aforementioned third frequency band. In addition, the first capacitor C1 and the second capacitor C2 can be used to filter out low-frequency noise with respect to the antenna structure 100, and the first inductor LA can be used to filter out high-frequency noise with respect to the antenna structure 100. According to actual measurement results, the addition of the tunable capacitor 160 and the connection metal element 140 helps fine-tune impedance matching of the aforementioned first frequency band, and the addition of the fourth radiation element 150 helps increase the bandwidth of the aforementioned first frequency band. It must be understood that the connection metal element 140 does not make a substantial contribution to exciting the frequency bands of the antenna structure 100. In other words, even if the connection metal element 140 is removed, the antenna structure 100 may still cover the aforementioned first frequency band, second frequency band, and third frequency band.

In some embodiments, the component sizes and component parameters of the antenna structure 100 may be as described below. A total length L1 of the first radiation element 110 and the second radiation element 120 may be from 0.125 to 0.25 wavelength (λ/8 ~ λ/4) of the third frequency band of the antenna structure 100. A total length L2 of the first radiation element 110 and the third radiation element 130 may be from 0.125 to 0.25 wavelength (λ/8 ~ λ/4) of the first frequency band of the antenna structure 100. A length L3 of the connection metal element 140 may be from 0.0625 to 0.25 wavelength (λ/16 ~ λ/4) of the first frequency band of the antenna structure 100. A length L4 of the fourth radiation element 150 may be from 0.0625 to 0.125 wavelength (λ/16 ~ λ/8) of the first frequency band of the antenna structure 100. A width of the coupling gap GC may be from 3 mm to 8 mm. A width of the first coupling gap GC1 may be from 1 mm to 4 mm. A width of the second coupling gap GC2 may be from 0.5 mm to 8 mm. A capacitance of the first capacitor C1 may be from 22 pF to 77 pF. A capacitance of the second capacitor C2 may be from 22 pF to 77 pF. An inductance of the first inductor LA may be from 12 nH to 63 nH. In response to the first control signal SC1, the variable capacitance value X of the tunable capacitor 160 may be any value within a range from 0.1 pF to 30 pF. The ranges of the above component sizes and component parameters are obtained based on results of multiple experiments, which help optimize the operating bandwidth and impedance matching of the antenna structure 100.

The following embodiments will introduce different configurations and detailed structural features of the antenna structure 100. It must be understood that these drawings and descriptions are merely examples and are not intended to limit the patent scope of the present disclosure.

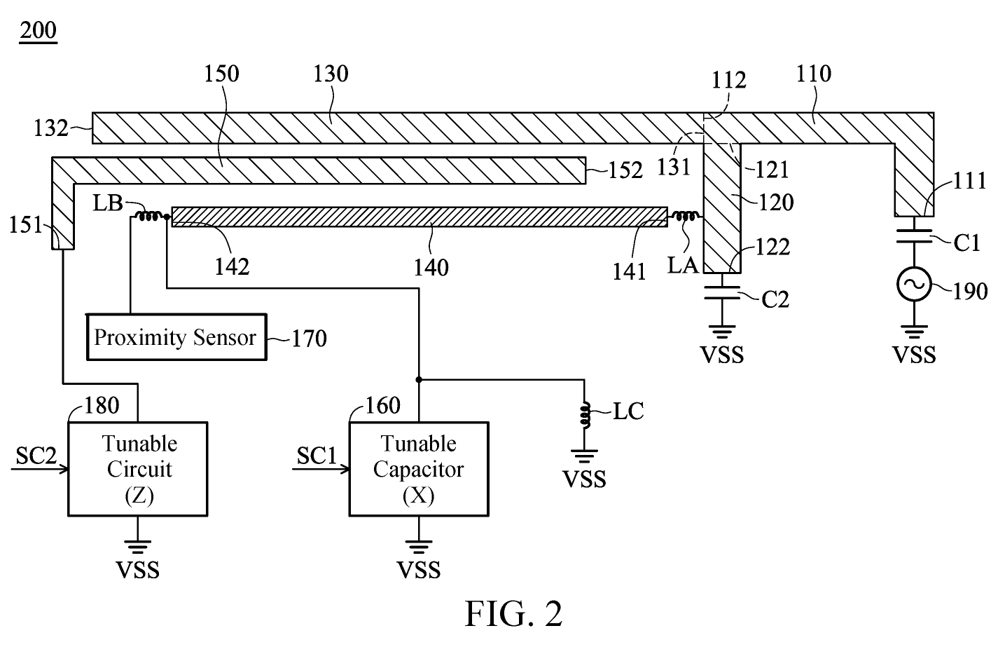

FIG. 2 is a schematic diagram showing an antenna structure 200 according to an embodiment of the present disclosure. FIG. 2 is similar to FIG. 1. In the embodiment of FIG. 2, the antenna structure 200 further includes a proximity sensor 170, a tunable circuit 180, a second inductor LB, and a third inductor LC. The second inductor LB is coupled between the second end 142 of the connection metal element 140 and the proximity sensor 170. The second end 142 of the connection metal element 140 can be further coupled through the third inductor LC to the ground voltage VSS. For example, an inductance of the second inductor LB may be from 210 nH to 450 nH, and an inductance of the third inductor LC may be from 57 nH to 270 nH. The first end 151 of the fourth radiation element 150 can be further coupled through the tunable circuit 180 to the ground voltage VSS. The tunable circuit 180 generates a variable impedance Z according to a second control signal SC2. For example, the aforementioned first control signal SC1 and the second control signal SC2 can both be generated by a processor based on a user input, but are not limited thereto. According to actual measurement results, the addition of the first inductor LA, the second inductor LB, and the third inductor LC can prevent the proximity sensor 170 from malfunctioning due to high-frequency noise concerning the antenna structure 200, and the application of the tunable circuit 180 can further improve the bandwidth of the first frequency band of the antenna structure 200. It must be understood that both of the first radiation element 110 and the third radiation element 130 can be configured as a sensing pad of the proximity sensor 170. Therefore, the antenna structure 200 can also be regarded as a hybrid antenna, which can simultaneously provide proximity sensing and specific absorption rate (SAR) suppression functions without additionally increasing the design area. The remaining features of the antenna structure 200 of FIG. 2 are all similar to the antenna structure 100 of FIG. 1, and therefore these two embodiments can achieve similar operational effects.

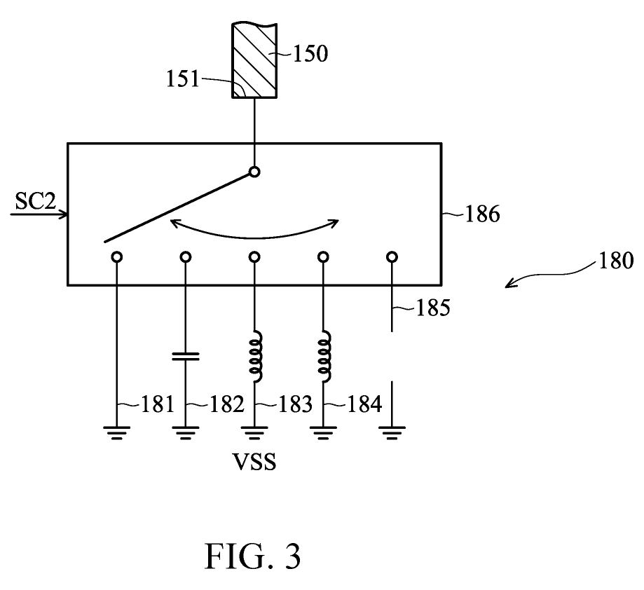

FIG. 3 is a structural diagram showing the tunable circuit 180 according to an embodiment of the present disclosure. In the embodiment of FIG. 3, the tunable circuit 180 includes a short-circuit path 181, a capacitive path 182, a first inductive path 183, a second inductive path 184, an open-circuit path 185, and a switch element 186. For example, the short-circuit path 181, the capacitive path 182, the first inductive path 183, the second inductive path 184, and the open-circuit path 185 may be coupled to the ground voltage VSS, and they can have different impedance values. In detail, one end of the switch element 186 is coupled to the first end 151 of the fourth radiation element 150, and the other end of the switch element 186 is switched between the short-circuit path 181, the capacitive path 182, the first inductive path 183, the second inductive path 184, and the open-circuit path 185 according to the second control signal SC2. That is, if the tunable circuit 180 uses the switch element 186 to select one of the short-circuit path 181, the capacitive path 182, the first inductive path 183, the second inductive path 184, and the open-circuit path 185, then the fourth radiation element 150 can be coupled to the ground voltage VSS through the single selected path. In addition, the remaining unselected paths remain in a non-conducting state and do not affect the variable impedance Z of the tunable circuit 180. In other embodiments, the tunable circuit 180 may further include fewer or more paths based on different requirements.

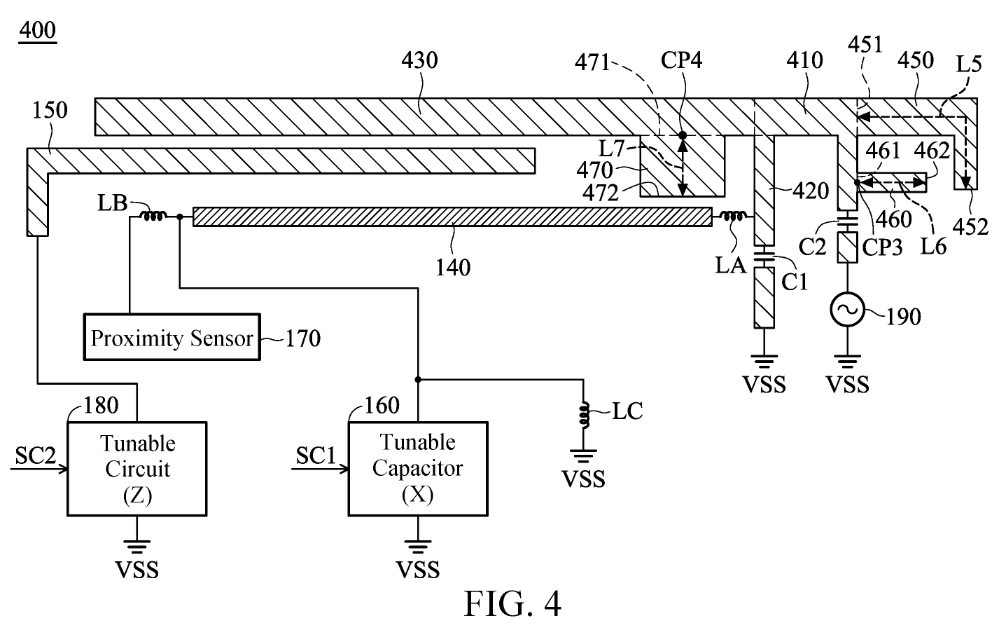

FIG. 4 is a schematic diagram showing an antenna structure 400 according to an embodiment of the present disclosure. FIG. 4 is similar to FIG. 2. In the embodiment of FIG. 4, the antenna structure 400 further includes a fifth radiation element 450, a sixth radiation element 460, and a seventh radiation element 470, all of which can be made of metal material. In addition, the shapes of each of a first radiation element 410, a second radiation element 420, and a third radiation element 430 of the antenna structure 400 are slightly adjusted, but do not affect their radiation functions. In detail, the fifth radiation element 450 has a first end 451 and a second end 452, wherein the first end 451 of the fifth radiation element 450 is coupled to a bent portion of the first radiation element 410, and the second end 452 of the fifth radiation element 450 is an open end. The sixth radiation element 460 is at least partially surrounded by the fifth radiation element 450. The sixth radiation element 460 has a first end 461 and a second end 462, wherein the first end 461 of the sixth radiation element 460 is coupled to a third connection point CP3 on the first radiation element 410, and the second end 462 of the sixth radiation element 460 is an open end. The seventh radiation element 470 has a first end 471 and a second end 472, wherein the first end 471 of the seventh radiation element 470 is coupled to a fourth connection point CP4 on the third radiation element 430, and the second end 472 of the seventh radiation element 470 is an open end and can extend in a direction toward the connection metal element 140. For example, a length L5 of the fifth radiation element 450 may be from 0.0625 to 0.125 wavelength (λ/16 ~ λ/8) of the second frequency band of the antenna structure 400, a length L6 of the sixth radiation element 460 may be from 0.0625 to 0.125 wavelength (λ/16 ~ λ/8) of the third frequency band of the antenna structure 400, and a length L7 of the seventh radiation element 470 may be from 4 mm to 6 mm, but is not limited thereto. According to actual measurement results, the addition of the fifth radiation element 450, the sixth radiation element 460, and the seventh radiation element 470 helps further improve impedance matching of the second frequency band and the third frequency band of the antenna structure 400. The remaining features of the antenna structure 400 of FIG. 4 are all similar to the antenna structure 200 of FIG. 2, and therefore these two embodiments can achieve similar operational effects.

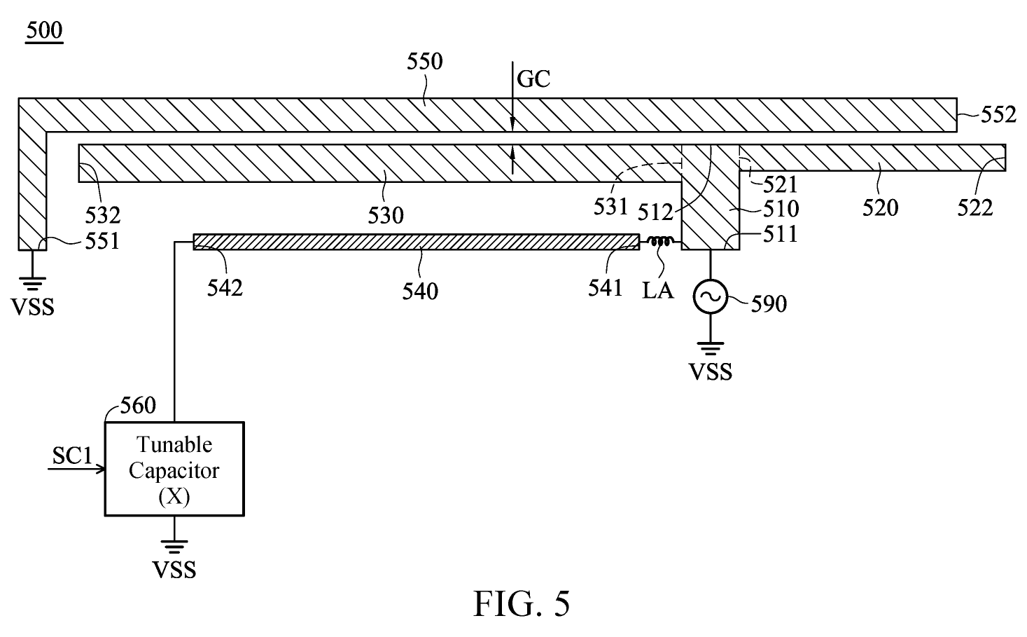

FIG. 5 is a schematic diagram showing an antenna structure 500 according to another embodiment of the present disclosure. FIG. 5 is similar to FIG. 1. In the embodiment of FIG. 5, the antenna structure 500 includes a first radiation element 510, a second radiation element 520, a third radiation element 530, a connection metal element 540, a fourth radiation element 550, a tunable capacitor 560, and a first inductor LA. The first radiation element 510, the second radiation element 520, the third radiation element 530, and the fourth radiation element 550 can all be made of a metal material. For example, the combination of the first radiation element 510, the second radiation element 520, and the third radiation element 530 may substantially have a T-shape, and the fourth radiation element 550 may may substantially have an L-shape. In detail, the first radiation element 510 has a first end 511 and a second end 512, wherein the first end 511 of the first radiation element 510 is coupled to a signal source 590. The second radiation element 520 has a first end 521 and a second end 522, wherein the first end 521 of the second radiation element 520 is coupled to the second end 512 of the first radiation element 510, and the second end 522 of the second radiation element 520 is an open end. The third radiation element 530 has a first end 531 and a second end 532, wherein the first end 531 of the third radiation element 530 is coupled to the second end 512 of the first radiation element 510, and the second end 532 of the third radiation element 530 is an open end. For example, the second end 522 of the second radiation element 520 and the second end 532 of the third radiation element 530 may extend substantially in opposite directions away from each other. The connection metal element 540 has a first end 541 and a second end 542, wherein the first end 541 of the connection metal element 540 is coupled through the first inductor LA to the first end 511 of the first radiation element 510, and the second end 542 of the connection metal element 540 is coupled through the tunable capacitor 560 to a ground voltage VSS. The fourth radiation element 550 has a first end 551 and a second end 552, wherein the first end 551 of the fourth radiation element 550 is coupled to the ground voltage VSS, and the second end 552 of the fourth radiation element 550 is an open end. For example, the second end 522 of the second radiation element 520 and the second end 552 of the fourth radiation element 550 may extend substantially in the same direction. In some embodiments, the fourth radiation element 550 is adjacent to the third radiation element 530, and a coupling gap GC may be formed between the third radiation element 530 and the fourth radiation element 550. In addition, the tunable capacitor 560 generates a variable capacitance value X according to a first control signal SC1. According to actual measurement results, the antenna structure 500 can also cover a first frequency band, a second frequency band, and a third frequency band, wherein the aforementioned first frequency band may be from 617 MHz to 960 MHz, the aforementioned second frequency band may be from 1400 MHz to 2690 MHz, and the aforementioned third frequency band may be from 3300 MHz to 5925 MHz. The remaining features of the antenna structure 500 of FIG. 5 are all similar to the antenna structure 100 of FIG. 1, and therefore these two embodiments can achieve similar operational effects.

The present disclosure provides a novel antenna structure. Compared with conventional designs, the present disclosure has at least the advantages of compact size, wide bandwidth, and the ability to additionally combine a proximity sensor, and therefore is well suited for application in various types of mobile communication devices.

Although the present disclosure has been disclosed above with specific preferred embodiments, it is not intended to limit the present disclosure. A person skilled in the art can still make some modifications and refinements without departing from the spirit and scope of the present disclosure. Therefore, the protection scope of the present disclosure should be defined by the claims below.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. An antenna structure comprising:
a first radiation element;
a first capacitor, wherein the first radiation element is coupled through the first capacitor to a signal source;
a second radiation element, coupled to the first radiation element;
a second capacitor, wherein the second radiation element is further coupled through the second capacitor to a ground voltage;
a third radiation element, coupled to the first radiation element;
a connection metal element;
a first inductor, wherein the connection metal element is coupled through the first inductor to the first radiation element or the second radiation element; and
a tunable capacitor, generating a variable capacitance according to a first control signal, wherein the connection metal element is further coupled through the tunable capacitor to the ground voltage.

2. The antenna structure of claim 1, further comprising:
a proximity sensor;
a second inductor, coupled between the connection metal element and the proximity sensor; and
a third inductor, wherein the connection metal element is further coupled through the third inductor to the ground voltage.

3. The antenna structure of claim 2, wherein the first radiation element and the third radiation element are configured as a sensing pad of the proximity sensor.

4. The antenna structure of claim 1, wherein a coupling gap is formed between the connection metal element and the third radiation element, and a width of the coupling gap is from 3 mm to 8 mm.

5. The antenna structure of claim 1, wherein the antenna structure covers a first frequency band, a second frequency band, and a third frequency band.

6. The antenna structure of claim 5, further comprising:
a fourth radiation element, coupled to the ground voltage, wherein the fourth radiation element is adjacent to the third radiation element and the connection metal element.

7. The antenna structure of claim 6, further comprising:
a tunable circuit that generates a variable impedance according to a second control signal, wherein the fourth radiation element is further coupled through the tunable circuit to the ground voltage.

8. The antenna structure of claim 7, wherein the tunable circuit comprises:
a short-circuit path, coupled to the ground voltage;
a capacitive path, coupled to the ground voltage;
a first inductive path, coupled to the ground voltage;
a second inductive path, coupled to the ground voltage;
an open-circuit path, coupled to the ground voltage; and
a switch element, coupled to the fourth radiation element, wherein the switch element is switched between the short-circuit path, the capacitive path, the first inductive path, the second inductive path, and the open-circuit path according to the second control signal.

9. The antenna structure of claim 6, wherein a first coupling gap is formed between the third radiation element and the fourth radiation element, a second coupling gap is formed between the connection metal element and the fourth radiation element, a width of the first coupling gap is from 1 mm to 4 mm, and a width of the second coupling gap is from 0.5 mm to 8 mm.

10. The antenna structure of claim 5, wherein the first frequency band is from 617 MHz to 960 MHz, the second frequency band is from 1400 MHz to 2690 MHz, and the third frequency band is from 3300 MHz to 5925 MHz.

11. The antenna structure of claim 5, wherein a total length of the first radiation element and the second radiation element is from 0.125 to 0.25 wavelength of the third frequency band.

12. The antenna structure of claim 5, wherein a total length of the first radiation element and the third radiation element is from 0.125 to 0.25 wavelength of the first frequency band.

13. The antenna structure of claim 5, wherein a length of the connection metal element is from 0.0625 to 0.25 wavelength of the first frequency band.

14. The antenna structure of claim 6, wherein a length of the fourth radiation element is from 0.0625 to 0.125 wavelength of the first frequency band.

15. The antenna structure of claim 1, further comprising:
a fifth radiation element, coupled to the first radiation element;
a sixth radiation element, coupled to the first radiation element, wherein the sixth radiation element is at least partially surrounded by the fifth radiation element; and
a seventh radiation element, coupled to the third radiation element.

16. The antenna structure of claim 1, wherein a capacitance value of each of the first capacitor and the second capacitor is from 22 pF to 77 pF.

17. The antenna structure of claim 1, wherein an inductance value of the first inductor is from 12 nH to 63 nH.

18. The antenna structure of claim 2, wherein an inductance value of the second inductor is from 210 nH to 450 nH.

19. The antenna structure of claim 2, wherein an inductance value of the third inductor is from 57 nH to 270 nH.

20. An antenna structure comprising:
a first radiation element, coupled to a signal source;
a second radiation element, coupled to the first radiation element;
a third radiation element, coupled to the first radiation element, wherein the second radiation element and the third radiation element extend substantially in opposite directions;
a fourth radiation element, coupled to a ground voltage, wherein the fourth radiation element is adjacent to the third radiation element;
a connection metal element;
a first inductor, wherein the connection metal element is coupled through the first inductor to the first radiation element; and
a tunable capacitor, generating a variable capacitance according to a first control signal, wherein the connection metal element is further coupled through the tunable capacitor to the ground voltage.
